(19) United States
(12) Patent Application Publication
(10) Pub. No.: US 2012/0297646 A1
(43) Pub. Date: Nov. 29, 2012

(54) Multi-adaptable power automated traction apparatus

(76) Inventor: Jean Brault, Cowansville (CA)

(21) Appl. No.: 13/068,829

(22) Filed: May 23, 2011

(51) Int. Cl. A43B 5/00; B62B 17/00; A63C 11/00

(52) U.S. Cl. 36/124; 280/809; 280/28; 280/816; 36/127

(57) ABSTRACT

A multi-adaptable power automated apparatus used for gaining traction on various surfaces comprising: snow, and/or ice to name some. Further assisting with accelerating, decelerating, turning, and/or stopping of a person(s) and/or vehicle(s); yet further compatible in/or on water.

### BACKGROUND

The concept of adapting and integrating traction parts to skis, snowshoes, shoes, boots or wheels, and tires, is nothing new. Although there are fewer attempts at integrating traction to skis. This being said however, there are breakthroughs in this field as well. For example: Sealskins well known to the art; are placed over the bottom surface of the ski, to meet directly with the ice or snow covered terrain. This method provides some traction on snow however, less so, on ice and is essentially used in ascending terrain. Other drawbacks are; having to mount and dismount the sealskins. This demands some effort and time, with the inconvenience of having to carry the said sealskins in a backpack or other transportable storage means for later use. More so does this become annoying when terrain changes frequently, from ascent to descent. Another example of this is found with U.S. Pat. No. 5,966,844 entitled “ SHORT, WIDE, LIGHT WEIGHT PORTABLE SKI APPARATUS FOR ATTACHMENT TO A SNOWSHOE ” and is hereby included as reference. Here again the same problems are encountered as with the previous example.

In more recent years, some have tried to remedy this problem, such as described with U.S. Pat. No. 7,150,464 B2 entitled “ CONFIGURABLE SNOWSHOE AND SKI DEVICE ” and is hereby included as reference. Herein, traction means are permanently integrated to a ski. This does save some effort, and time as with not having to remove the traction parts completely, as with is done with regards to the previous examples. Yet there still remains some given effort, and time, where one as to stop, and manually engage the traction system, or manually disengage it, before skiing on. However the present embodiment does make for effortless on/off traction readily at hand, for example: by simply pressing a button, on a ski pole grip, that transmits a remote controlled signal(s) and/or wireless signal(s) to a pair of skis. Wherein each ski is equipped with a power pneumatic(s) apparatus, that extracts and/or retracts pins used for traction and are deployed underneath the skis base without having to dismount the skis, or even without having to stop skiing. This is achieved without effort, and in a fraction of time compared with any of the previous art. Remaining with the present embodiment. Not only does the present embodiment make available effortless on/off traction for skis. But adapts the same effortless on/off traction to numerous other transport means and footwear applications, that will become more apparent in the summary, and claims of the present embodiment.

### SUMMARY

A power automated apparatus used for gaining traction, speed, and/or used for braking, stopping, that can even assist with turning of a moving person(s), and/or vehicle(s), but not limited to. For example: on difficult (rough, vertical), and/or ice and snow covered surfaces (terrains), even providing traction on/or in water, but not limited to. The said apparatus, is adaptable to numerous applications where traction is partly needed and/or needed at all times. Furthermore wherein traction performance is adjustable for example: via dedicated servo controller (that enables, a preprogrammed repeated course of travel and/or position that a traction part must stop). The said apparatus is adaptable to many numerous applications, that comprises: skis, snowshoes, shoes (golf shoes), boots (ice climbing boots), skibob (snow bike), snowmobile skis to name some application, but not limited to.

Remaining with the present embodiment, and without being bound by theory. A power automated traction apparatus that is both wired and/or wireless via remote control for example: Being said wired or said wireless is dependent on the required needs that may differ from one application to the next of the present embodiment, but not limited to. Another example would be: a snowmobile, wherein said apparatus as pneumatic activated traction parts, installed onto the snowmobile skis and powered via the snowmobile. Herein the said apparatus may be controlled via a wired system. For there is no need for wireless control in this application. The fact being that there is no physical separation or adequate distance between the skis and the snowmobile for wireless necessity. Therefore the controls maybe placed near the hand grips on the handle bars, wherein wires run from said controls to skis on the snowmobile. However some applications do require said wireless remote control.

One example therefore comprise: Where the said power automated traction apparatus is integrated to alpine skis. Herein each ski will need a separate said apparatus and it becomes obvious to control both skis simultaneously, or individually. Herein wireless remote control, is a more adequate solution, and further adding that controls via a ski pole grip would be preferable.

Such a combination, may serve multiple purposes. For control on vertical surface conditions having hard pack snow and/or ice covered surfaces. Herein the said apparatus helps with slowing down. Furthermore the said apparatus is meant to facilitate control of said skis, whether it be in descending, or ascending terrain.

One example of assent is where on/off ascending terrain is met. Herein the said apparatus is integrated to cross-country skis for traction when climbing. The said apparatus is activated via a wireless remote control that is integrated via a ski pole grip, facilitating on/off traction at will, by simply pressing a button, and without having to stop skiing to activate.

Yet still in another example: wherein snowmobile skis on a snowmobile are each fitted with the said apparatus having pneumatic actuator means fitted upon each skis that exerts pressure on a center blade (so that the blade is pushed down gripping deeper into the snow or rising it for less traction). Wherein said center blade is located underneath the center of the ski base, of each ski. This arrangement permits sharper assisted turning of the vehicle by adding pressure via the pneumatic actuators to one or both ski blades. And is preferably controlled and activated from the said snowmobile via a control(s) positioned near one or both hand grips on the handle bars.

The same process can further be adapted and applied to the edges of alpine skis. This process would therefore amplify the qualities found with parabolic skis, well known to the art.

Remaining with the present embodiment. Even though the said apparatus may differ in components, and methods from one application to the other; Yet it still achieves the same purpose.

Further characteristics and advantages will become more apparent from the detailed description, illustrated by non-limitative example.

### BRIEF DESCRIPTION OF THE DRAWINGS

FIG. 1 shows an isometric view of a ski pole handle; and further showing some internal components.

FIG. 2 shows a isometric view of an alpine ski with toe (front) ski binding shown on the left, and heel (back) ski bindings; shown on the right wherein a pneumatic actuator is shown at the far (right side) of the heel ski binding.

### DETAILED DESCRIPTION OF THE INVENTION

The present invention is described with reference to the drawings.

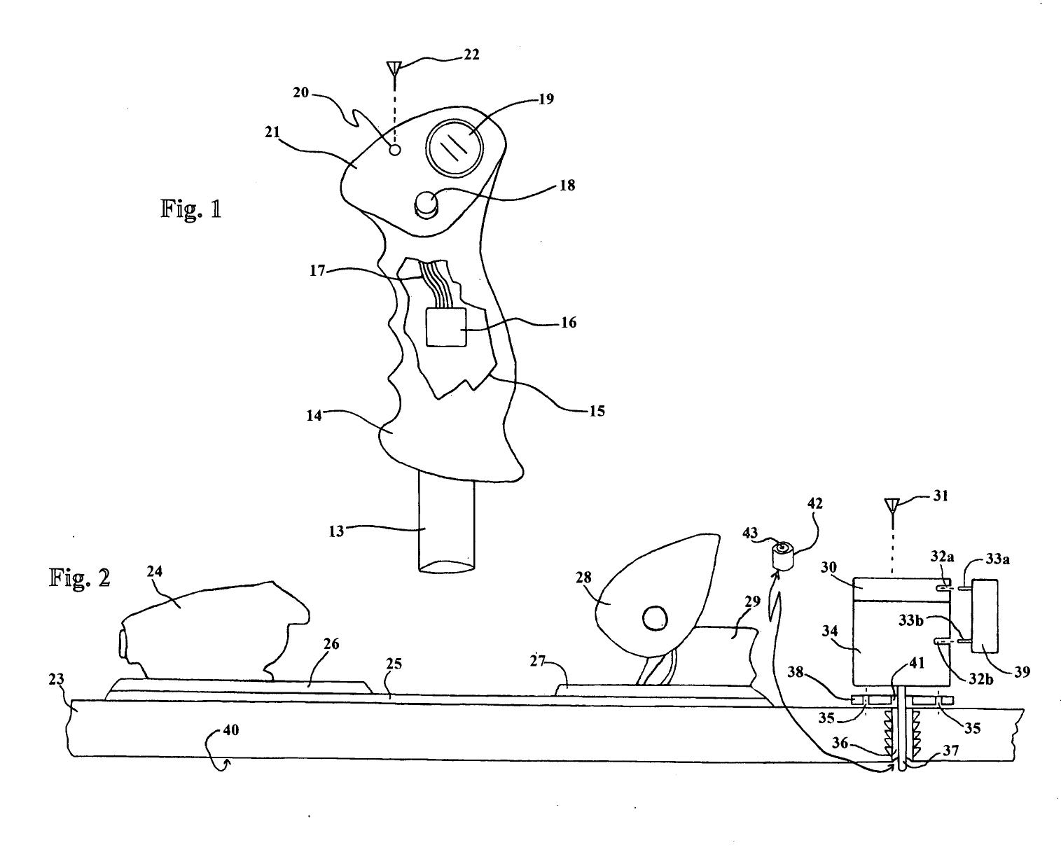

FIG. 1 shows a wireless signal transmitter command means via, a ski pole grip 14, having a common cylindrical ski pole shaft 13 that enters the grip 14, and that is securely engaged within grip 14. The center and lower portions of ski pole shaft 13 are (not shown) yet further shows an internal view of grip 14, via the internal portion of structural outline 15. Herein a transmitter 16, connected to wires 17, that extend upward to engage one or more batteries (not shown), that is positioned underneath the battery cover 19. Battery cover 19 screws into top platform 21 of grip 14. Wires 17 further connect to transmitter antenna 22 (connection not shown), that sits inside hole 20; this interior antenna arrangement prevents damage to transmitter antenna 22 that may occur otherwise, via impact for obvious reasons. The top platform 21, of ski pole grip 14, is slightly tilted inward via the skier (not shown) so that the command (switch) button 18, is easily, and comfortably access using the thumb finger (not shown). Command (switch) button 18 is connected to wires 17 (not shown).

FIG. 2 shows an alpine ski-bindings arrangement comprising: a power automated traction apparatus; having wireless signal receiver means that is generated via the ski pole grip (FIG. 1) 14, wherein ski 23 having a toe binding 24 that is supported on front supporting plate 26. And a heel binding 29 having a retaining jaw 28, is supported on rear supporting plate 27. Mounted on the ski 23 is base platform 25 supporting plates 26, and 27. Between toe binding 24 and heel binding 29, herein a ski boot (not shown) is held in place via retaining jaw 28. At the rear end (the far right) of base platform 25 sits fixation plate 38, on ski 23; wherein 38 is positioned to give free movement to retaining jaw 28. Sited on fixation plate 38 is a pneumatic actuator 34; and on actuator 34 sits a controls compartment 30. This assembly is anchored

using bolts (not shown) that traverses from the top of the controls compartment 30, down through the pneumatic actuator 34, and passing into holes 35, of the fixation plate 38; to anchor into ski 23 via treaded inserts (not shown). A rechargeable DC power pack 39 having two (male) connectors; comprising: 33a, and 33b, engage (female) receiving connectors 32a, and 32b. That is 33a via 32a, and 33b via 32b. The advantages are clear using power pack 39. This system permits easy engagement-removal not unlike DC power packs found with power tools. And furthermore enables, replacing the power pack 39 when it needs recharging with one that is fully charged, without having to wait for the initial power pack to recharge, using a recharger unit (not shown). A two-way communications system is provided via: a receiver antenna 31 located on the top surface of controls compartment 30, that receives communications signals via the transmitter antenna 22 (FIG. 1) located on the top platform 21 (FIG. 1) of ski pole grip 14 (FIG. 1). This process is achieved by way, of pressing the command (switch) button 18 (FIG. 1). This in turn activates the pneumatic actuator 34 to extend and/or retract the rod 37 (that can be done so, at will). Rod 37 when fully extended, traverses several parts comprising: hole 41 of fixation plate 38, pressure set insert 36, via ski 23, and bushing 42 via hole 43 wherein bushing 42 is pressure set inside insert 36 and flush with ski base 40. 42 is a preventive measure to stop snow and/or ice from building inside insert 36. Finally rod 37 reaches pass the ski base 40 to create friction with the snow and/or ice surface (not shown) that produces the desired traction.

Although particular embodiments of the invention herein have been described, it is not limited to this description. It is therefore to be understood that numerous modifications may be made to the embodiments without departing from the spirit and scope of the present invention. And that other embodiments are to be found in the claims.

1. A multi-adaptable power automated apparatus conceived, for traction (gripping, friction, adhesion) on surfaces comprising: snow and/or ice, in/or on water, but not limited to; said apparatus is used when accelerating, and/or decelerating and/or, when stopping (immobilizing), or when turning, of a moving person(s), and/or vehicle(s), craft(s), but not limited to.

2. Remaining with the present embodiment; said apparatus to claim 1, is made of materials comprising: metal, carbon materials, plastic, rubber, but not limited to, and as various shapes (forms) that are dependent according to a specific need; therefore said apparatus to claim 1, is preferably compatible with skis comprising: hybrid ski-snowshoe, cross-country ski, alpine ski, backcountry ski, snowboard, skibob (crossover of a bike, and snow board), snowmobile ski, (snowmobile ski blade, but not limited to); yet is further compatible with: snowshoe, shoe (golf shoe, but not limited to), boot (ice climbing boot, but not limited to), sled, lag, still further comprising: a cleat (that can be placed under a boot, shoe), but not limited to.

3. Said apparatus to claim 1, as traction parts that come in contact with said surfaces to claim 1, but not limited to; therefore; said traction parts to claim 3, comprises: pins, claws, scoops, hocks, nails, round ended and/or jagged parts, screws, bolts, treaded spindles, pins, spring pins (spring plunger), reverse action spring pins, blades, ski edges or a combination thereof, but not limited to; furthermore, said apparatus to claim 1, is programmed to deploy, said traction parts to claim 3, in single or multiple deployment means or a combination thereof, but not limited to.

4. Said apparatus to claim 1, being said power automated to claim 1, is therefore powered via: AC power pack(s) units, or via one or more batteries, one or more rechargeable batteries, rechargeable unit(s) solar cell(s), solar panel(s), but not limited to, DC power, wireless energy transfer (wireless power) comprising: Inductive coupling, laser, direct induction and resonant magnetic induction, to name some, but not limited to; said power means to claim 4, but not limited to; in turn activate single or multiple moving parts comprising: linear stage servo motor, servo motor, electric activated pneumatic (actuator(s)) (cylinder and/or slide table, electric rotating rod actuator(s)), electric motor(s) but not limited to; still remaining with claim 4; herein other power means comprising: compressed CO2, compressed air, and/or other compressed gas forms in disposable and/or reusable (cartridges, containers, cylinders), and/or via: an air compressor; in turn activating moving parts comprising: air pneumatic (actuator(s)): rotating rod actuator(s), but not limited to; still other means comprising: hydraulics, combined air/hydraulics; yet, other power means comprising: a combustion engine, but not limited to, that in turn activate an alternator, but not limited to.

5. Remaining with the present embodiment, said apparatus to claim 4, dependent on specific needs, that may differ from one application to the other, and in accordance to claims 1, and 2; is remotely activated and controlled via, remote control, comprising: infra red transmitter, radio transmitter, HF modules, infrared Data Association (IrDA), microwave, radio frequency and/or Bluetooth connectivity via various means comprising: one-way, or two-way signals, but not limited to, wireless means, mobile phone, Smartphone computer, through module, zero-set sensor; other frequencies: Digital Enhanced Cordless Telecommunications (DECT) comprising: Wi-Fi, MHZ, or, GHz, KHz, UHF band, communications, but not limited to: or via induction (inductive coupling), laser, but not limited to, still further comprising: circuit board, circuit arrangement, microprocessor, sensor(s), servo motor, electrical switch(s), but not limited to.

6. Where distance between said moving parts to claim 4, and said traction parts to claim 3, therein are parts comprising: piston(s), threaded spindle(s), bolt(s), screw(s), rod(s), threaded rods, but not limited to, and are adjustable length wise to obtain repeated preset positioning, and to amplify, and/or reduce traction, via means comprising: reed switch, inductive proximity switch, anisotropic magneto resistive sensor (AMR), dedicated servo controller, linear encoder (for position, thrust, and velocity control), pneumatic valve positioner (air lock relay(s)) but not limited to; may further comprise: manually adjustable means, with position locking via: treaded rod(s), rack and pinion, spring plunger, but not limited to.

7. Said apparatus to claim 1, integrated with said ski to claim 2, but not limited to; is preferably activated via: electric and/or electronic moving parts wherein; position, thrust, and/or velocity are controllable; and therefore comprising: servo motor(s), electric activated pneumatic actuator(s) comprising: electric cylinder actuator, electric slide table actuator and/or electric linear stage actuator, electric rotating rod actuator, electric treaded rod actuator, electric moving coil actuator; however, other activation means, may comprise: air pneumatic actuator(s) comprising: air cylinder actuator, air slide table actuator/air linear stage actuator, air rotating rod actuator, air treaded rod actuator, and/or air-hydraulic pneumatic actuator(s), solenoid activated pneumatic (magnetic and/or electromagnetic means), but not limited to; manually operating parts comprising: cable(s) mechanisms, rack and pinion, but not limited to.

8. Said apparatus to claim 7, integrated with said ski, but not limited to; is remotely controlled using means to claim 5, and is preferably done so via a ski pole grip (handle), but not limited to.

9. Said apparatus to claim 1, may further comprise, heating components, stationary parts and/or moving parts via: electronics, electric, air and/or hydraulics use; other than specified to claims, 3 and 6, and 7; therefore, further comprising: pressure sensors, proximity sensors,
photoelectric sensors, linear encoders, linear displacement sensors, electrodes, heat element resistors, thermoelectric device(s), heat sinks, amplifier circuits, liquid crystal display screen (LCD), fixed gas detectors, temperature transmitters, contact temperature sensors, weight sensors, force sensors, torque sensors, humidity sensors, electric dedicated servo controller, electric dedicated amplifier, but not limited to; still further comprising: air/gas line(s) tubing, hydraulic oil line(s), temperature sensors, humidity air line filter, air flow regulator, spokes, cables, springs, hydraulic oil (fluids), electrical wiring, but not limited to.

10. Said apparatus to claim 9, may further comprise: anti solar flare (magnetic wave) preventive materials, comprising: stainless steel, invar, glucydur, nivarox, elinvar, but not limited to.

11. Remaining with the present embodiment, said AC power pack(s), to claim 4, but not limited to; can engage or disengage said apparatus, to claims 2, and, 7, but not limited to; via: cordless, portable, compact, power means, not unlike power packs coupled to power tools, well known to the art; other said cordless, portable, compact power means to claim 11, may comprise: compressed CO2, compressed air, and/or other compressed gas forms in disposable and/or reusable (cartridges, containers, cylinders) to claim 4, but not limited to; that can furthermore, engage or disengage said apparatus, to claims 2, and, 7, but not limited to, not unlike said CO2 cartridge power means that are found in air rifles, well known to the art.
